(19) United States
(12) Patent Application Publication
(10) Pub. No.: US 2012/0006450 A1
(43) Pub. Date: Jan. 12, 2012

(54) ZINC DIFFUSION COATING METHOD

(75) Inventors: Wolfram Graf, Essen (DE); Frank Natrup, Essen (DE)

(73) Assignee: Bodycote Warmebehandlung Gmbh, Ebersbach (DE)

(21) Appl. No.: 13/146,316

(22) PCT Filed: Jan. 27, 2010
(86) PCT No.: PCT/EP10/00489

§ 371 Date: Sep. 29, 2011

(30) Foreign Application Priority Data
Jan. 27, 2009 (DE) 10 2009 006 190.8

(51) Int. Cl. B05D 3/02; B05D 3/12; B05D 3/10; C21D 1/00

(52) U.S. Cl. 148/527

(57) ABSTRACT

A method for diffusion coating a surface of a metal substrate with zinc comprises the steps of: a₁) applying a suspension, comprising a liquid and zinc and/or a zinc alloy as a diffusion source or zinc donor, onto the surface of the substrate to be coated, or a₂) applying a liquid onto the surface of the substrate to be coated and subsequently applying zinc and/or a zinc alloy as a diffusion source or zinc donor onto the liquid; and b) drying the substrate obtained in step a₁) or a₂); c) carrying out a heat treatment of the substrate obtained in step b) at a temperature between 200 and 500° C., but below the melting temperature of the diffusion source in a shielding gas atmosphere; and d) removing the mixture applied in step a₁) or a₂).

The present invention relates to a method for the diffusion coating of a surface of a metallic substrate with zinc in which the substrate to be coated is heat-treated together with zinc as a diffusion source at temperature between 200 and 500° C. but below the melting temperature of the diffusion source.

Components of materials susceptible to corrosion such as for example of iron and steel have been zinc coated for a long time, i.e. provided on their surface with a comparatively thin zinc layer in order to increase the corrosion resistance of the components. Examples for such components are joining and fastener elements such as screws and bolts, body parts for motor vehicles, crash barriers, railings, outdoor stairs and the like. By way of example hot melt zinc coating, galvanic zinc coating and sheradizing are known as zinc coating methods.

In hot dip zinc coating the substrate to be coated is dipped after an appropriate pre-treatment, which normally includes the steps of degreasing, pickling, fluxing and drying, into a zinc melt which normally has a temperature between 440 and 460° C. and is left for an adequate period of time in this melt before the so coated substrate is removed from the melt, cooled down and if necessary post-treated. A disadvantage of hot dip zinc coating manifests itself when the attempt is made to coat heat-treated high strength steel parts, since under the influence of the relatively high process temperature these can decisively loose strength and in this way become unusable.

With galvanic zinc coating, the application of the zinc layer onto the material to be zinc-plated takes place by electrochemical deposition from a zinc electrolyte. This method is, however, only conditionally utilizable for substrates of complex shape. Furthermore, heat-treated high strength steel parts cannot be treated with this method in order to preclude the danger of hydrogen embrittlement.

A further known zincing method is the sheradizing method in which the material to be zinc coated is heat-treated with zinc powder, mainly in a mixture with an inert material of filler such as sand or ceramic, for example aluminum oxide, at a temperature between 320 and 420° C. The method is normally carried out in a heated rotating drum which is also termed a retort in which the material to be zinc coated is embedded in the mixture of the zinc powder and filler before the drum is sealed off in air-tight manner after filling and heated to the required temperature. The filler used in the sheradizing method has several tasks. On the one hand it serves for uniform heating, for a gentle cleaning off of the components and for a homogeneous distribution of the zinc powder. Moreover, in the case of bulk material, it also prevents the parts striking together and thus damaging of the components. Sheradizing methods relates to a diffusion coating method in which the zinc is diffused into the surface layer of the substrate to be zinc coated from the vapor phase which is formed as a result of a comparatively high vapor pressure of zinc by sublimation at the temperature used for the heat treatment. Such methods are for example described in DE-PS 134 594, in DE-PS 273 654 and by E. V. Proskurkin & N. S. Gorbunov, “Galvanizing, sheradizing and other zinc diffusion coatings” Technicopy Limited, England, 1972, pages 1 to 68.

With the sheradizing method very uniform zinc coatings which adhere firmly to the substrate with a layer thickness of up to 100 μm are produced even when using substrates of complicated shape and have an excellent corrosion resistance. However, the known sheradizing methods have some disadvantages.

One disadvantage of the known sheradizing method is the comparatively high consumption of zinc which is caused by the burned-off of zinc in the initial air atmosphere present in the reaction space with an oxygen concentration of 21 Vol.-%, because the burned-off zinc is no longer available for the coating.

Moreover, disadvantages are associated with the use of the filler and indeed both for complex components which are mainly fixed in frames in the drum and also for the process itself. As a result of the self-weight of the filler undesired deformations of the material to be zinc coated can namely arise. Furthermore, as a result of the heat capacity of the filler consideranbly more heat energy is required for the method than is the case lithe filler could be dispensed with. Furthermore the filler requires additional process steps and handling devices. Thus the filler must be added into the drum prior to the sheradizing and subsequently separated from the coated material and cleaned for re-use. The fine dust burden due to filler abrasion and zinc ash is of concern and thus requires special measures to be taken for working protection, such as extraction systems or respiration masks. If the filler material is dispensed with in order to avoid these disadvantages then practice shows that the process no longer leads to layer formation with the usual zinc metering and thus fails or that the zinc consumption related to the zinc coated surface is considerably increased.

Furthermore the use of loose zinc dust during the heat treatment is complicated because this requires an adequate distribution of the zinc dust in the retort which is normally achieved by a moved retort, in particular a rotating retort during the heat treatment and, on the other hand, because the handling of dust is of concern from technical environmental and technical working viewpoints.

Finally, the retorts that are normally used in the sheradizing method are also disadvantageous. Normally, for the above-named reason, retorts are used for this purpose which rotate in an oven or are moved in order to achieve a uniform distribution of the zinc dust and of the filler and in order to achieve a situation in which the number of ovens can be kept smaller than the number of retorts. Because the retorts rotate within the heating chamber of the oven the seals also lie inside the firing space. Since these are not completely sealed air and gaseous oxygen-containing combustion products can enter into the retorts during the heat treatment which impairs the reliability of the process and also in particular increases the consumption of zinc for the above-named reasons.

The object of the present invention is thus the making available of a method for diffusion coating of the surface of the substrate with zinc in which even when using substrates of complicated shape very uniform zinc coatings can be obtained with an excellent resistance to corrosion which firmly adhere to the substrate, which does not have to be carried out in a rotating or otherwise moved retort, which has a reduced zinc consumption related to the surface of the substrate to be zinc coated and which makes it possible to dispense with the use of filler and the use of loose zinc dust during the heat treatment.

In accordance with the invention this object is satisfied by making available a method in accordance with patent claim 1 and in particular a method for the diffusion coating of a surface of a metal substrate with zinc which includes the following steps_{—}
a₁) application of a suspension which contains a liquid and zinc and/or a zinc alloy as a diffusion source or zinc donor onto the surface of the substrate to be coated, or
a₂) application of a liquid onto the surface of the substrate to be coated and subsequent application of zinc and/or of a zinc alloy as a diffusion source or zinc donor onto the liquid
   and
b) drying of the substrate obtained in the step a₁) or a₂),
c) carrying out a heat treatment of the substrate obtained in the step b) at a temperature between 200 and 500° C. but below the melting temperature of the diffusion source under a protective gas atmosphere and also
d) removing the mixture applied in the step a₁) or a₂).

In the context of the present invention it could surprisingly be found that with a method based on zinc diffusion for the coating of a surface of a metallic substrate it is possible to dispense during the heat treatment with the use of filler, with the use of loose zinc powder and with a movement of the retort in which the heat treatment is carried out, when, in the method prior to the heat treatment, through the method step a₁) or the method step a₂) in combination with the drying in accordance with the method step b), zinc is firmly adhered to the substrate surface to be coated and the substrate with the zinc firmly adhered thereto is subsequently subjected to a heat treatment under a protective gas atmosphere. In distinction to the classical sheradizing method, in which loose zinc powder or zinc dust is used during the heat treatment as the diffusion source, in the method of the invention zinc or zinc alloy which firmly adheres to the surface of the substrate to be coated is used as the diffusion source. For this reason, in the method of the invention, it is possible to dispense with both the use of loose zinc dust and also with the use of filler material. In this way a situation is achieved, amongst other things, in which the method of the invention only has a low energy requirement and deformations of the substrate to be coated are reliably prevented. Moreover, for this reason, the charge density of the substrates to be coated in the retort, in which the heat treatment is carried out, can be considerably increased because no volume of the retort is lost for filler and loose zinc dust. Finally, an at least substantially dust-free and thus environmentally friendly carrying out of the method is also made possible thereby.

Since, in the method of the invention, the need is also avoided to move the retorts in which the heat treatments is carried out, i.e. the use of movable rotating retorts can consequently be dispensed with, the retorts which are used in the reaction spaces used for the method of the invention can be designed considerably more simply in distinction to the movable retorts positioned in the oven normally used in the sheradizing method. This reduces the investment costs. In particular the substrates to be coated in the method of the invention in the reaction space do not have to be mounted on a frame in distinction to the movable retorts normally used in the sheradizing method. Moreover, in the method of the invention, as a result of dispensing with movable retorts which have to be rotatably arranged in the firing chamber of an oven, it is possible to utilize normal protective gas technology or vacuum furnace technology. Through the gas tight design the entry of air during the heat treatment can be reliably prevented. In this way, in combination with the heat treatment under the protective gas atmosphere, a situation is achieved in which no burning off of zinc by reaction with oxygen takes place during the heat treatment, so that the zinc consumption related to the surface of the substrate to be zinc coated is very low and indeed even when the use of a filler is dispensed with. Moreover, the zinc consumption in the method of the invention is further reduced in that it is possible, as a result of the application of the zinc as a firmly adherent layer onto the substrate surface to be coated prior to the carrying out of the heat treatment, to only apply as much zinc to the substrate surface as is required for the later coating. For this reason, the zinc that is used in the method of the invention is at least almost entirely consumed. For this reason also the method costs in the method of the invention are significantly less than in the methods known from the prior art.

Under a protective gas atmosphere in the sense of the present patent application one understands a gas or gas mixture which contains less than 10%, preferably less than 1%, particularly preferably less than 100 ppm, even more preferably less than 10 ppm, quite especially preferably less than 1 ppm and most preferably a maximum of 0.1 ppm oxygen.

In accordance with a first preferred embodiment of the present invention the application of the diffusion source of zinc takes place in accordance with the method step a₁), i.e. a suspension is applied onto the surface of a substrate to be coated which contains a liquid and zinc and/or a zinc alloy. As a liquid water and particularly preferably distilled water is preferably used. Since water or liquid containing water reacts or will react with zinc at elevated temperatures with hydrogen formation a cooled suspension is preferably used in method step a₁) and indeed particularly preferably a suspension cooled to a temperature of less than 20° C. and more particularly preferably to a temperature of less than 10° C. Alternatively to water liquid hydrocarbons, alcohols or ketones or other liquids or liquid mixtures can be used as the liquid, providing these are volatile, likewise react in restricted manner with zinc and are preferably able to dissolve salts. Preferred examples for this are trichloroethylene, dichloromethane, benzol, xylol, toluol or C₁-C₁₀ alcohols in particular methanol, ethanol, propanol and butanol. A favorably priced method with water makes it possible, as a result of the low viscosity of the suspension, to apply this suspension uniformly also onto regions of the substrate surface which are of difficult access, even with substrates to be coated of complicated shape, so that in the heat treatment which takes place after the subsequent drying these regions of the substrate surface are also uniformly coated with zinc.

In this first embodiment of the present invention a good adhesion of the zinc or of the zinc alloy to the substrate surface to be coated is achieved by the drying of the suspension applied to the substrate surface which takes place in the method step b). In order to improve the adhesion of the zinc or of the zinc alloy onto the substrate surface to be coated after the drying at least one further compound can be added to the suspension used in the method step a₁) in addition to the liquid and the zinc or the zinc alloy, which is selected from the group which consists of dispersing agents, binding agents, wetting agents and any desired mixtures of two or more of the above-named compounds. While the dispersing agents improve the homogeneity of the suspension and thus a uniform application of the diffusion source onto the substrate surface and the wetting agents facilitate the wetting of the substrate surface, the binding agent acts as an adhesive which improves the adhesion.

In accordance with a second preferred embodiment of the present invention the application of the diffusion source zinc takes place in accordance with the method step a₂), i.e. a liquid is first applied to the surface of a substrate to be coated, preferably a bond promoting agent, before zinc and/or zinc alloy is subsequently applied onto the liquid or the bond promoting agent. As a liquid or bond promoting agent a solvent is preferably used, optionally in a mixture with at least one further compound which is selected from the group consisting of dispersing agents, binder agents, wetting agents and any desired mixtures of two or more of the above-named compounds. As a solvent water and particularly preferably distilled water is preferably used. Alternatively to water, liquid hydrocarbons, alcohols and ketones or other liquids or liquid mixtures can also be used as a solvent, providing these are volatile, likewise react restrictedly with zinc and are preferably able to dissolve salts. Preferred examples for this are trichloroethylene, dichloromethane, benzol, xylol, toluol or C₁-C₁₀ alcohols in particular methanol, ethanol, propanol and butanol.

A good adhesion of the zinc or zinc alloy on the surface to be coated is also achieved in the second embodiment of the present invention by the drying which takes place in the method step b) of the liquid applied to the substrate surface or of the bond promoting agent applied to the substrate surface and of the zinc. To improve the adhesion of the zinc or of the zinc alloy to the substrate surface to be coated after drying at least one compound can be added to the liquid or bond promoting agent used in the method step a₂) which is selected from the group consisting of dispersing agents, binding agents, wetting agents and any desired mixtures of two or more of the above-named compounds.

Independently of whether the diffusion source is applied in accordance with the method step a₁) or alternatively to this in accordance with the method step a₂) it is preferred that the suspension applied in the method step a₁) and the liquid/bond promoting agent applied in the method step a₂) contains at least one binding agent, with the binding agent preferably being selected from the group consisting of halogen salts, sulfates, sulfites, phosphates, silicates, boron compounds, water glass and any desired mixtures of two or more of the above-named compounds. Particularly good results are in particular achieved when the binding agent consists of zinc chloride, sodium chloride, potassium chloride, ammonium chloride, zinc sulfate and any desired mixtures of two or more of the above-named compounds. These compounds have the advantage that they are temperature-resistant at the temperature at which the heat treatment is carried out, i.e. between 200 and 500° C. Moreover, they are readily water-soluble which is why they can easily be removed again from the coated substrate after the heat treatment. Furthermore, the above-named salts also act as fluxes and activators. Finally, the salts corrosively attack the substrate and the zinc dust so that in this way any oxide present on the substrate surface is removed.

As wetting agents the suspension applied in the method step a₁) or the liquid/bond promoting agent applied in the method step a₂) preferably contains a compound which is selected from the group consisting of tensiles and alcohols. Examples for suitable alcohols are methanol, ethanol, propanol, butanol or pentanol.

The suspension applied in the step a₁) or the liquid applied in the step a₂) is preferably cooled to a temperature of less than 20° C. and preferably to a temperature of less than 10° C. prior to the application to the substrate.

An exemplary suspension suitable for carrying out a first embodiment of the present invention can for example consist of water saturated with sodium chloride, zinc, zinc chloride (for example in a quantity of 1% by weight) and alcohol (preferably ethanol or methanol).

An example for a bond promoting agent suitable for carrying out a second embodiment of the present invention is for example a solution consisting of water, sodium chloride, zinc chloride and alcohol (preferably ethanol or methanol).

For reasons of good suspendability zinc in the form zinc powder or zinc dust with an average particle size of a maximum of 100 μm, preferably of maximum 20 μm and particularly preferably of a maximum of 10 μm is used in the method step a₁) or alternatively to this in the method step a₂). Good results are in particular achieved with zinc powder or zinc dust with an average particle size between 3 and 6 μm and with a maximum particle size of 70 μm.

Furthermore, it is preferred for the zinc that is used to have a zinc content between 90 and 100% by weight and particularly preferably a zinc content between 99 and 100% by weight.

The present invention is not restricted with respect to the way in which the suspension is applied to the substrate in the method step a₁) or the liquid or the bond promoting agent is applied to the substrate in the method step a₂). This can, for example, take place by spraying, immersing, coating, rolling or by brush painting.

Through the drying carried out in the method step b) the diffusion medium i.e. the zinc or the zinc alloy is adhered to the substrate surface. The drying preferably takes place in the method step b) at a temperature between 40 and 250° C. In order to assist the drying process the substrate can be additionally heated prior to coating, i.e. prior to the step c) and preferably prior to the step b) to a temperature preferably between 40 and 250° C.

The heat treatment which takes place in the method step c) can basically be carried out at any temperature and for any duration known for customary sheradizing processes. Preferably the heat treatment is carried out at a temperature between 300 and 420° C. and particularly preferably at a temperature between 340 and 410° C. The heat treatment should, however, preferably be carried out at a temperature which is lower than the melting temperature of the diffusion source, i.e. of the zinc or zinc alloy applied in the step a₁) or a₂), because otherwise the danger of sintering of the substrate surface arises.

The duration of the heat treatment can for example amount to between 10 minutes and 10 hours.

As explained above, the heat treatment is carried out in accordance with the invention under a protective gas atmosphere with a protective gas atmosphere here being designated as a gas or a gas mixture which contains less than 10% oxygen. Particularly good results are obtained when the protective gas atmosphere contains, during the heat treatment in method step c), less than 1%, particularly preferably less than 100 ppm, even more preferably less than 10 ppm, quite particularly preferably less than 1 ppm and most preferably at most 0.1 ppm oxygen.

Examples for corresponding protective gases are noble gases, nitrogen, methane, C₁-C₄ alkanes, C₁-C₄ alkenes, alkines, silanes, hydrogen and ammonia.

The present invention is basically not limited with respect to the pressure at which the heat treatment is carried out. By way of example the heat treatment can be carried out at atmospheric pressure or under an excess pressure of up to 1.5 bar, preferably of between 1.02 and 1.2 bar. This ensures that in the event of an undesired leakage in the retort during the heat treatment no air enters into the retort.

However, it is just as readily possible to carry out the heat treatment at an under-pressure, for example at a pressure between 10⁻² and 0.99 bar and preferably between 1 and 10 mbar.

As explained above the method in accordance with the invention is preferably carried out without filler. It is however also possible, even though this is less preferred, to add a little filler to the retort. In this, less preferred case, it is however advantageous if the filler content in the retort during the heat treatment amounts, related to the volume of the reaction space, to less than 20%, particularly to less than 10% and especially preferably to less than 1%.

For the carrying out of the heat treatment, the retort, together with the substrate to be coated which is located therein with the diffusion source adhering to it, is first heated to the heat treatment temperature before the temperature is maintained for a time adequate for the heat treatment and the retort is finally cooled down to room temperature. Heat treatment in the sense of the present patent application will be understood to be the time interval during which the temperature required for the heat treatment is maintained, i.e. excluding the heating up phase and the cooling down phase. In accordance with the invention the heat treatment is carried out under a protective gas atmosphere whereas no inert gas atmosphere has to be present during the heating up rate and/or during the cooling down phase, even though this is less preferred.

In accordance with a further preferred embodiment of the present invention, provision is made to set the oxygen content in the atmosphere contained in the reaction space in which the heat treatment is carried out. prior to the start of the heat treatment, i.e. before the temperature is achieved at which the heat treatment is carried out, i.e. already prior to or at the latest during the heating up phase, to less than 10%, preferably to less than 1%, particularly preferably to less than 100 ppm and even more preferably to less than 10 ppm, quite particularly to less than 1 ppm and most preferably to a maximum of 0.1 ppm. In this way it is reliably prevented that zinc is burned off by oxygen during the heating up of the reaction space.

Furthermore, it is likewise preferred, in accordance with a further preferred embodiment of the present invention, in the reaction space in which the method step c) is carried out, to maintain the oxygen content in the protective gas atmosphere contained in the reaction space at less than 10%, preferably less than 1%, particularly less than 100 ppm, even more preferably to less than 10 ppm, quite particularly preferably to less than 1 ppm and at most preferably to a maximum of 0.1 ppm oxygen until the temperature in the reaction space has cooled down or has been cooled down to less than 200° C. after the termination of the heat treatment. In this way, the formation of a sintered cake can be reliably prevented.

Furthermore, it is preferred when the mixture or the diffusion source or zinc donor applied in the method step a₁) or in the method step a₂) is removed from the coated substrate after the heat treatment for example by washing, by ultrasonic treatment or by brushing of the coated substrate.

Moreover, the coated substrate can be passivated after the heat treatment and indeed preferably after the removal of the mixture applied in the method step a₁) or in the method step a₂).

In a further development of the concept of the invention it is proposed that the substrate be cleaned prior to the application in accordance with the method step a₁) or the method step a₂), preferably by mechanical surface treatment. This can for example take place with a blasting medium, by pickling in alkaline or acidic solutions and/or by treatment with a flux.

The method in accordance with the invention is particularly suited for the coating of substrates which consists of a metal which can be alloyed with zinc, preferably of iron and its alloys, such as for example steel and cast iron, of copper and its alloys and/or of aluminum and its alloys.

1. A method for the diffusion coating of a surface of a metallic substrate with zinc including the steps:
a₁) application of a suspension which contains a liquid and zinc and/or a zinc alloy as a diffusion source or zinc donor onto the surface of the substrate to be coated, or
a₂) application of a liquid onto the surface of the substrate to be coated and subsequent application of zinc and/or of a zinc alloy as a diffusion source or zinc donor onto the liquid
and
b) drying of the substrate obtained in the step a₁) or a₂),
c) carrying out a heat treatment of the substrate obtained in the step b) as a temperature between 300 and 500° C. but below the melting temperature of the diffusion source under a protective gas atmosphere and also
d) removing the mixture applied in the step a₁) or a₂) by cleaning the coated substrate by washing, ultrasonic treatment or brushing.

2. A method in accordance with claim 1, characterized in that the suspension applied in the step a₁) contains, in addition to the liquid and the zinc and/or the zinc alloy at least one further compound which is selected from the group consisting of dispersing agents, binder agents, wetting agents and any desired mixtures of two or more of the above-named compounds.

3. A method in accordance with claim 1, characterized in that the liquid applied in the step a₂) contains a solvent and optionally at least one further compound which is selected from the group consisting of dispersing agents, binder agents, wetting agents and any desired mixtures of two or more of the above-named compounds.

4. A method in accordance with claim 1, characterized in that the liquid of the suspension applied in the step a₁) or the solvent of the liquid applied in the step a₂) contains or is a compound which is selected from the group consisting of water, alcohols, liquid hydrocarbons, ketones and any desired mixtures of two or more of the above-named compounds.

5. A method in accordance with claim 4, characterized in that the liquid of the suspension applied in the step a₁) or the solvent of the liquid applied in the step a₂) contains or consists of trichloroethylene, dichloromethane, benzol, xylol, toluol or a C₁-C₁₀ alcohol.

6. A method in accordance with claim 2, characterized in that the suspension applied in the step a₁) or the liquid applied in the step a₂) contains at least one binder agent which is selected from the group consisting of halogen salts, sulfates, sulfites, phosphates, silicates, boron compounds, water glass and any desired mixtures of two or more of the above-named compounds.

7. A method in accordance with claim 6, characterized in that the suspension applied in the step a₁) or the liquid applied in the step a₂) contains at least one binder agent which is selected from the group consisting of zinc chloride, sodium chloride, potassium chloride, ammonium chloride, zinc sulfate and any desired mixtures of two or more of the above-named compounds.

8. A method in accordance with claim 2, characterized in that the suspension applied in the step a₁) or the liquid applied in the step a₂) contains at least one wetting agent which is selected from the group consisting of tensides, methanol, ethanol, propanol, butanol and pentanol.

9. A method in accordance with claim 1, characterized in that the suspension applied in the step a₁) or the liquid applied in step a₂) is cooled prior to the application to the substrate of a temperature of less than 20° C.

10-12. (canceled)

13. A method in accordance with claim 1, characterized in that the drying in the step b) is carried out at a temperature between 40 and 250° C.

14. A method in accordance with claim 1, characterized in that the substrate is heated prior to the coating to a temperature between 40 and 250° C.

15. A method in accordance with claim 1, characterized in that the heat treatment in the step c) is carried for a time between 10 minutes and 10 hours at a temperature between 300 and 420° C.

16. A method in accordance with claim 1, characterized in that the heat treatment in the step c) is carried out under a protective gas atmosphere and contains less than 100 ppm oxygen.

17-18. (canceled)

19. A method in accordance with claim 1, characterized in that the heat treatment is carried out at a pressure between 1 and 1.5 bar.

20. A method in accordance with claim 1, characterized in that the heat treatment is carried out at a pressure between 10⁻² and 0.99 bar.

21. A method in accordance with claim 1, characterized in that the heat treatment is carried out at a pressure between 1 and 10 mbar.

22. A method in accordance with claim 1 characterized in that less than 1% filler material is present in the reaction space during the heat treatment related to the volume of the reaction space.

23. A method in accordance with claim 1, characterized in that before the start of the heat treatment in the reaction space in which the step c) is carried out, the oxygen content in the atmosphere contained in the reaction space is set to less than 10 ppm and the heat treatment is then started and carried in the reaction space in the atmosphere so produced.

24. A method in accordance with claim 1, characterized in that in the reaction space in which the step c) is carried out, the oxygen content in the protective gas atmosphere contained in the reaction space is set or maintained at less than 10 ppm until the temperature in the reaction space after the termination of the heat treatment has been cooled down to or has cooled down to less than 200° C.

25-26. (canceled)

27. A method in accordance with claim 1, characterized in that the substrate consists of a metal which can be alloyed with zinc, of iron and its alloys, of copper and its alloys and/or of aluminum and its alloys.
